(19) United States
(12) Patent Application Publication
(10) Pub. No.: US 2006/0024204 A1
(43) Pub. Date: Feb. 2, 2006

(54) Well plate sealing apparatus and method

(76) Inventor: Kevin R. Oldenburg, Spokane, WA (US)

Correspondence Address: ROBERT S. LIPTON, ESQUIRE, 201 NORTH JACKSON STREET, P. O. BOX 934, MEDIA, PA, 19063-0934, US

(21) Appl. No.: 10/903,881

(22) Filed: Aug. 2, 2004

(51) Int. Cl. B01L 3/00

(52) U.S. Cl. 422/99; 422/102

(57) ABSTRACT

The Invention is an apparatus and method for selectably sealing wells in a plurality of well plates. A plurality of lids and a plurality of gaskets are adapted to cover the wells of each well plate. A compression device is adapted to receive and to selectably compress the plurality of well plates, gasket and lids and to thereby selectably seal the wells of the well plate.

### FIELD OF THE INVENTION

The Invention relates to the storage, transportation and handling of liquid samples, particularly liquid samples contained in the wells of a well plate. The Invention allows the convenient and reusable sealing of wells of a plurality of well plates without contamination of the liquid samples contained within the wells.

### BACKGROUND OF THE INVENTION

Nucleic acid amplification is typically performed by PCR or Cycle Sequencing of DNA in the wells of a well plate by thermal cycling reactions in the presence of a thermostable DNA polymerase such as Taq Polymerase. Well plates containing wells for 96, 384 and 1536 liquid samples currently are available. The solution in which the amplification occurs typically contains many different components including but not limited to, a buffer, nucleotide triphosphates, magnesium chloride, potassium chloride, dithiothreotol, DNA, oligonucleotides, and the DNA polymerase (e.g. Taq). Once the amplification process of the DNA is complete, the reaction solution contains not only the components listed above but reaction byproducts as well.

The liquid samples used in the wells of a well plate are quite small and subject to loss through evaporation, water uptake and extraneous contamination. Two different types of seals to protect liquid samples in the wells of a well plate typically are available: “sticky film” and heat-sealed film.

The “sticky film” type of seal is a thin sheet of film having an adhesive coating. The adhesive-coated sheet of film is large enough to cover the entire upper surface of the well plate. The adhesive bonds the “sticky film” to the entire upper surface, sealing the liquid samples in and contamination out. “Sticky film” has several disadvantages. First, when the film is removed from the well plate to allow access to the samples, a residue of adhesive is left behind. When well plates are stacked, this adhesive residue can bond one well plate to another, preventing plates with adhesive residue from being used in automated plate handling devices.

Second, the “sticky film” adhesive is soluble in many of the solvents used in the field. The result is that the adhesive bond between the sticky film and the well plate is weakened, allowing delamination of the film from the well plate and loss of the seal protecting the well contents. The soluble nature of the adhesive also allows contamination of liquid samples with dissolved adhesive.

Finally, “sticky film” does not work well in an automated environment and must be applied and removed by hand.

The second common method of sealing liquid samples within wells of a well plate involves heat-sealed film, which also has disadvantages. First, the heating process typically heats the film and the top of the microwell plate to 160 to 180 degrees C. The elevated temperatures melt the top of the microwell plate, substantially shortening the life of the well plate and allowing the well plate to be sealed once or, at most, several times.

Second, most heat-sealed films may not be peeled from the well plate. For a non-peelable film, the only way to access the contents of the well plate is to puncture the film above the well. If another layer of heat-sealed film is applied, the contents of the wells become increasingly difficult to access through the multiple layers of film, since not all wells are punctured at any one time.

Although some heat-sealed films are peelable, peelable heat-sealed films have disadvantages. The peelable heat-sealed films are composed of plastic laminates. The portion of the plastic laminate that melts to form the seal with the well plate generally is soluble in many of the solvents typically used in the field. The issue of solubility of the plastic leads to delamination of the film from exposure to solvents and contamination of samples by the dissolved plastic.

The present Invention avoids the difficulties presented by the prior art.

### SUMMARY OF THE INVENTION

The Invention is an apparatus for conveniently storing, transporting and handling liquid samples contained in the wells of a plurality of well plates, such as the well plates used for DNA amplification using PCR or cycle sequencing reactions. As used in this application, the term “liquid” refers to pure liquids, as well as liquids containing particulate matter (especially biological material containing for example, proteins, DNA, or cells) and solvents containing solute.

A lid having a resilient gasket is provided for each well plate. Each gasketed lid is adapted to be placed on a well plate so that the lid covers the wells of the well plates.

A compression device also is provided. The compression device accepts a stack of well plates with gasketed lids. The compression device includes a pressure plate operated by a cam lever. The cam lever has two positions and selectably moves the pressure plate, thereby selectably applying pressure to the stack of well plates and gasketed lids. When pressure is applied by the pressure plate to the stack of well plates and gasketed lids, the gaskets are compressed, thereby sealing each of the wells of each of the well plates in the stack. When pressure is released from the pressure plate, the stack of well plates may be removed from the compression device for manipulation of the liquid samples contained in the wells.

The compression device apparatus is adapted to accept a plurality of stacks of well plates. The compression device is equipped with openings to facilitate removal of the stack of well plates from the compression device and is equipped with handles to facilitate transportation and handling of the compression device.

### BRIEF DESCRIPTION OF THE DRAWINGS

FIG. 1 is a perspective view of the compression device of the Invention.

FIG. 2 is a perspective view of a prior art well plate.

FIG. 3 is a perspective view of a well plate with the gasketed lid in place.

FIG. 4 is a cross section of the well plate with the gasketed lid in place.

FIG. 5 is a front view of the compression device.

FIG. 6 is a top view of the compression device.

FIG. 7 is a detail of the lever cam.

FIG. 8 is a side view of the compression device.

### DESCRIPTION OF AN EMBODIMENT

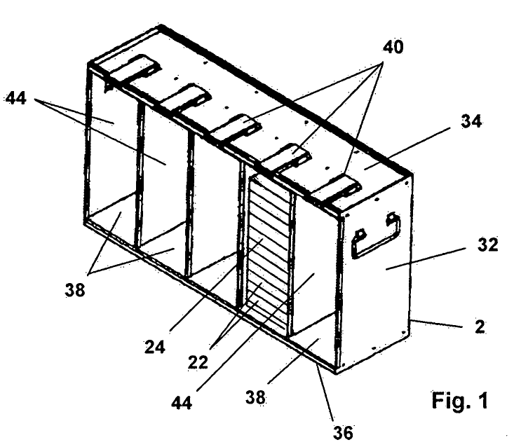

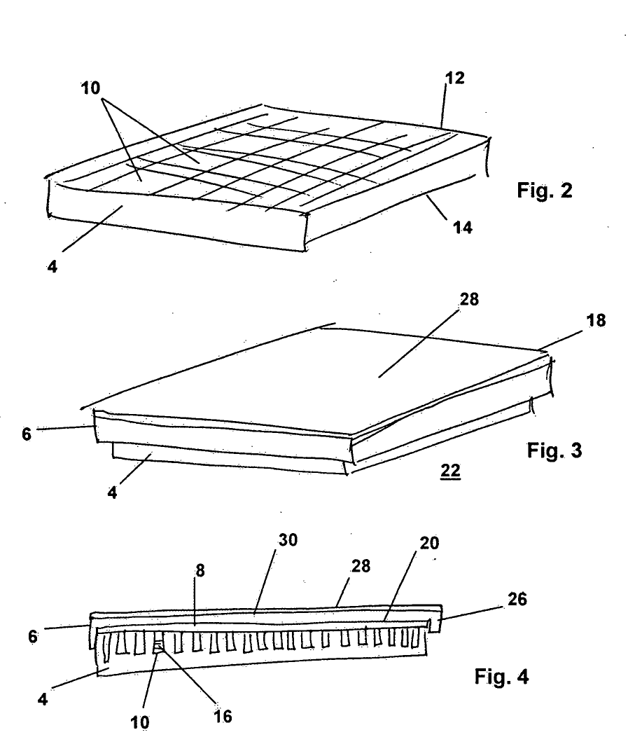

FIG. 1 shows the compression device 2 of the Invention and FIGS. 2-4 show the well plate 4, lid 6 and gasket 8 to be inserted in the compression device 2. As shown by FIG. 2, a prior art well plate 4 includes wells 10, a top surface 12, and a bottom surface 14. Liquid samples 16 are contained within the wells 10.

As shown by FIGS. 3 and 4, a lid 6 includes a top side 18 and a bottom side 20. Gasket 8 engages the bottom side 20 of lid 6 and covers the wells 10 of well plate 4. The well plate 4, in combination with the lid 6 and gasket 8 in place on the well plate 4, is a covered well plate assembly 22. When a plurality of covered well plate assemblies 22 are placed one on top of the other with the bottom surface 14 of the well plate 4 being supported by the top side 18 of the lid 6, the result is referred to herein as a “well plate stack” 24.

The bottom surface 14 of a well plate 4 may engage the top side 18 of a lid 6 in the well plate stack 24 only at the periphery of the well plate 4 due to the construction of well plates 4. The lid 6 must be adequately stiff to receive a load transmitted by a well plate 4 at the periphery of the lid 6 and transmit that load throughout the lid 6 to compress the gasket 8 and seal each of the wells 10 in the well plate 4.

A lid 6 composed of polystyrene plastic 26 coupled to a thin stainless steel plate 28 has proven to be adequately stiff to receive a load at the periphery of the lid 6 and to adequately convey the load to compress the gasket 8 and seal all of the wells 10. Bonding the thin stainless steel plate 28 to the polystyrene lid 6 using pressure sensitive adhesive 30 has proven successful.

The gasket 8 must be adequately resilient to compress upon pressure placed on the lid 6 and to seal the wells 10 of the well plate 4. The gasket 8 should composed of a material resistant to all solvents typically used with well plates 4. Closed cell EPDM foam has proven to work very well in this application. The closed cell EPDM foam is chemically resistant, compressible under a wide range of temperatures (80 degrees C. to 100 degrees C.) and can be reused several times because the foam does not exhibit memory of the compression.

The construction of the compression device 2 is illustrated by FIGS. 1 and 5-8. The compression device 2 includes a case 32 having a case top side 34 and a case bottom side 36. The case bottom side 36 defines a pressure surface 38. The case top side 34 supports a lever cam 40, shown by FIGS. 1, 5 and 6 and by detail FIG. 7. The lever cam 40 bears against and actuates a pressure plate 42.

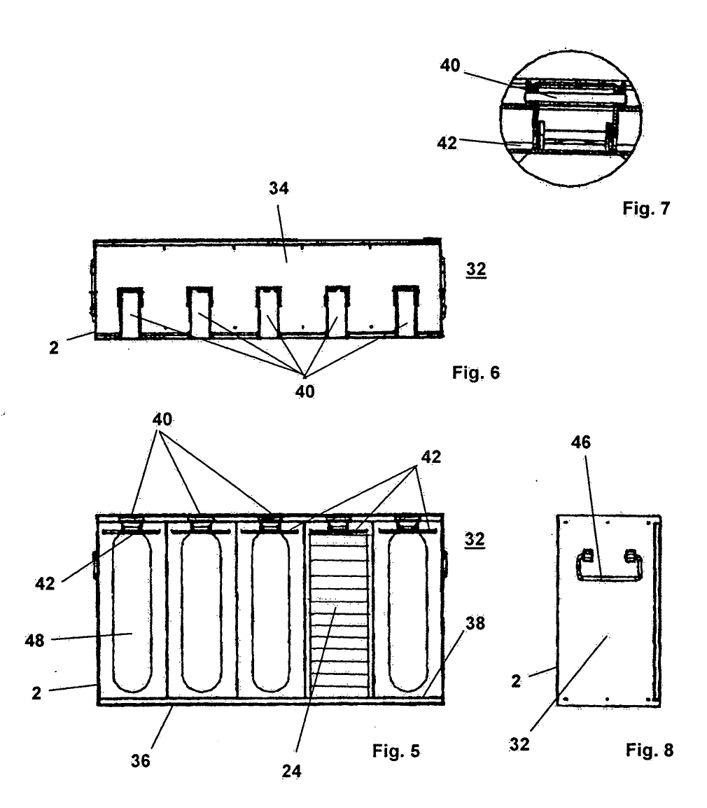

The pressure plate 42 and the pressure surface 38 define a well plate 4 receiving opening 44. A stack 24 of well plates 4 with lids 6 and gaskets 8 may be placed within the well plate-receiving opening 44. A stack 24 of well plates 4 within the well plate-receiving opening 44 is illustrated by FIGS. 1 and 5.

The lever cam 40, and hence the pressure plate 42, has a first and a second position. In the first position, the lever cam 40 and the pressure plate 42 are in a withdrawn position, allowing the stack 24 to be placed within the well plate-receiving opening 44. In the second position of the lever cam 40, the lever cam 40 presses on the pressure plate 42, which in turn presses on the uppermost lid 6 on the stack 24, thereby compressing the stack 24 between the pressure plate 42 and the pressure surface 38. The compression of the stack 24 compresses each of the gaskets 8 in the stack 24, thereby sealing each of the wells 10 of each of the well plates 4 in the stack 24.

To remove the stack 24 from the compression device 2, the lever cam 40 is returned to the first position. The pressure on the stack 24 is thereby released, decompressing the gaskets 8, unsealing the wells 10 in the well plates 4 and allowing the stack 24 to be removed from the case 32.

The case 32 of the compression device 2 can be configured to allow any convenient number of stacks 24 of well plates 4 to be stored. Cases 32 accommodating five or six stacks 24 of twelve well plates 4 have proven to be convenient. An opening 48 behind each stack 24 facilitates removal of a stack 24 from the case 32.

FIG. 8 is a side view of the compression device. Handles 46 are provided for ease of carrying of the case 32.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

I claim:

1. An apparatus for selectably sealing a plurality of wells in a plurality of well plates, the apparatus comprising:
a. a plurality of lids, each of said plurality of lids having a lower side and an upper side, each of the plurality of well plates having an upper surface and a lower surface, said upper side of each of said plurality of lids being adapted to engage said lower surface of one of the plurality of well plates;
b. a plurality of gaskets, each of said plurality of gaskets being adapted to engage said lower side of one of said plurality of lids, each of said plurality of gaskets further being adapted to engage said upper surface of one of said plurality of well plates;
c. a pressure plate;
d. a pressure surface in a spaced-apart relationship with said pressure plate;
e. a well-plate receiving space defined by said spaced apart relationship of said pressure plate and said pressure surface, said well-plate receiving space being adapted to receive the plurality of well plates, said plurality of gaskets and said plurality of lids, said pressure plate being adapted to selectably apply a pressure to the plurality of well plates, said plurality of gaskets and said plurality of lids thereby compressing each of said plurality of gaskets and sealing each of the wells in the plurality of well plates.

2. The apparatus of claim 1, further comprising: a case, said case having a case bottom side and a case top side, said case bottom side defining said pressure surface, said case top side supporting said pressure plate.

3. The apparatus of claim 2 wherein said pressure plate has a first position and a second position, said pressure plate when in said second position applying said pressure to said plurality of well plates and lids, said pressure plate when in said first position not applying said pressure to said plurality of well plates and lids whereby the plurality of well plates and said plurality of lids may be removed from the apparatus when said pressure plate is in said first position.

4. The apparatus of claim 3, further comprising: a lever cam, said case top side supporting said lever cam, said lever cam engaging said pressure plate, said lever cam adapted to select said first pressure plate position or said second pressure plate position.

5. The apparatus of claim 4 wherein said lever cam has a first lever cam position and a second lever cam position, said lever cam when in said first lever cam position selecting said first pressure surface position, said lever cam when in said second lever cam position selecting said second pressure surface position.

6. The apparatus of claim 5, further comprising:
a. said pressure plate comprises a plurality of said pressure plates, each of said plurality of pressure plates being supported by said case top side;
b. said case bottom side defines a plurality of said pressure surfaces, said plurality of pressure plates in combination with said plurality of said pressure surfaces defining a plurality of well plate receiving spaces.

7. The apparatus of claim 6 wherein each of said lids is configured so as to be sufficiently stiff to provide adequate distribution of said pressure to each of the wells of each of the well plates such that each of said gaskets seals each of said wells.

8. The apparatus of claim 7 wherein said lid is composed of a polystyrene plastic.

9. The apparatus of claim 8, further comprising: said adaptation of said upper lid side to engage said lower well plate surface comprising a metal plate.

10. The apparatus of claim 9 wherein said metal plate is composed of a stainless steel bonded to said polystyrene by a pressure sensitive adhesive.

11. An apparatus for selectably sealing the wells in a well plate stack where each of the plurality of well plates within the well plate stack is covered with a gasket and a lid, the apparatus comprising:
a. a pressure plate;
b. a pressure surface in a spaced-apart relationship with said pressure plate;
c. a well-plate receiving space defined by said spaced apart relationship of said pressure plate and said pressure surface, said well-plate receiving space being adapted to receive the stack of well plates having the gasketed lids, said pressure plate being adapted to selectably apply a pressure to the stack of well plates having gasketed lids, thereby sealing each of the wells in the plurality of well plates.

12. The apparatus of claim 11, further comprising: a case, said case having a case bottom side and a case top side, said case bottom side defining said pressure surface, said case top side supporting said pressure plate.

13. The apparatus of claim 12 wherein said pressure plate has a first position and a second position, said pressure plate when in said second position applying said pressure to said stack of well plates and gasketed lids, said pressure plate when in first second position not applying said pressure to said stack of well plates and gasketed lids.

14. The apparatus of claim 13, further comprising: a lever cam, said case top side supporting said lever cam, said lever cam engaging said pressure surface, said lever cam adapted to select said first pressure surface position or said second pressure surface position.

15. The apparatus of claim 14 wherein said lever cam has a first position and a second position, said lever cam when in said first lever cam position selecting said first pressure surface position, said lever cam when in said second lever cam position selecting said second pressure surface position.

16. The apparatus of claim 15, further comprising:
a. said pressure plate comprises a plurality of said pressure plates, each of said plurality of pressure plates being supported by said case top side;
b. said case bottom side defines a plurality of said pressure surfaces, said plurality of pressure plates in combination with said plurality of said pressure surfaces defining a plurality of well-plate receiving spaces.

17. A method for selectably sealing a plurality of wells in a plurality of well plates, the method comprising:
a. providing a plurality of lids and a plurality of gaskets, said plurality of lids and said plurality of gaskets having a number, said number of said plurality of lids and said plurality of gaskets equaling a number of the plurality of well plates;
b. placing a one of said plurality of gaskets and a one of said plurality of lids on each of said plurality of well plates so that each of said lids and each of said gaskets covers an upper well plate surface, said plurality of well plates, said plurality of gaskets and said plurality of lids forming a plurality of covered well plate assemblies;
c. stacking each of said plurality of covered well plate assemblies so that a top side of one of said plurality of lids supports a lower surface of one of said plurality of well plates to form a well plate stack;
d. placing said well plate stack between a pressure plate and a pressure surface;
e. applying a pressure by said pressure plate to said stack of well plate assemblies whereby each of said plurality of gaskets is compressed and each of the plurality of wells in each of the well plates is sealed.

18. The method of claim 17, further comprising the additional step of:
a. releasing said pressure;
b. removing said stack of well plate assemblies from between said pressure plate and said pressure surface.

19. The method of claim 18 wherein said case has a case top side and a case bottom side, said pressure surface is defined by said case bottom side and said pressure plate is actuated by a lever cam supported by said case top side.
